(19) United States
(12) Patent Application Publication
(10) Pub. No.: US 2015/0003656 A1
(43) Pub. Date: Jan. 1, 2015

(54) Garment With Waterproof Receptacle

(71) Applicant: Tech Innovations LLC, New York, NY (US)

(72) Inventor: Isadore Pardo, New York, NY (US)

(21) Appl. No.: 14/301,875

(22) Filed: Jun. 11, 2014

Related U.S. Application Data
(60) Provisional application No. 61/840,116, filed on Jun. 27, 2013.

(51) Int. Cl. H04R 1/44

(52) U.S. Cl. CPC H04R 1/44
USPC 381/334

(57) ABSTRACT

An article of swimming apparel includes a swimsuit adapted for wear in a wet environment and a waterproof receptacle coupled with the swimsuit for receiving a personal electronic device and protecting the personal electronic device against exposure to water or other liquids. The receptacle includes a waterproof speaker that facilitates transmitting audio signals from a personal electronic device disposed within the receptacle.

### CROSS-REFERENCE

This application claims the benefit of U.S. Provisional Patent Application Ser. No. 61/840,116, filed Jun. 27, 2013 (pending), the disclosure of which is incorporated by reference herein in its entirety

### TECHNICAL FIELD

The present invention relates generally to garments and, more particularly, to garments configured to protect an electronic device from exposure to water.

### BACKGROUND

The use of personal electronic devices, such as cellular telephones, digital audio players, and other electronic devices, is increasing in popularity. Many users enjoy listening to music, communicating with others, accessing the Internet, or viewing photos or videos during leisure or sport activities. In some environments, such as at or near a pool or beach, the use of electronic devices presents a danger that the device may become damaged if exposed to water. To protect electronic devices from exposure to water and other liquids, and to avoid the need for users of electronic devices to constantly hold their electronic devices while enjoying such sport or leisure activities, there is a need for a garment that allows users access to, and enjoyment of, their electronic devices while also permitting them to participate in sport or leisure activities where there is a risk of exposure to water.

### SUMMARY

The present invention overcomes the foregoing and other shortcomings and drawbacks associated with the need for a garment that allows users access to and enjoyment of their electronic devices while also permitting them to participate in sport or leisure activities where there is a risk of exposure to water. While the invention will be described in connection with certain embodiments, it will be understood that the invention is not limited to these embodiments. On the contrary, the invention includes all alternatives, modifications and equivalents as may be included within the spirit and scope of the present invention.

In one aspect in accordance with the principles of the present disclosure, an article of swimming apparel includes a swimsuit adapted for wear in a wet environment, and a waterproof receptacle coupled with the swimsuit for receiving a personal electronic device and protecting the personal electronic device against exposure to water or other liquids. The receptacle may include a waterproof speaker that facilitates transmitting audio signals from a personal electronic device disposed within the receptacle.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a schematic illustration depicting an exemplary garment including a waterproof electronic device receptacle in accordance with the principles of the present invention.

FIG. 2 is a front view of an exemplary waterproof electronic device receptacle in accordance with the principles of the present invention.

FIG. 3A is a front view an alternative embodiment of an exemplary waterproof electronic device receptacle in accordance with the principles of the present invention.

FIG. 3B is a rear view of the exemplary waterproof electronic device receptacle of FIG. 3A.

FIG. 4 is a front view of the exemplary waterproof electronic device receptacle of FIG. 3A, with an electronic device disposed within the reservoir.

FIG. 5 is a front view of yet another exemplary waterproof electronic device receptacle, illustrating an output connection.

It should be understood that the appended drawings are not necessarily to scale, presenting a somewhat simplified representation of various features illustrative of the basic principles of the invention. The specific features disclosed herein, including, for example, any specific dimensions, orientations, locations, and shapes of various illustrated components, will be determined in part by the particular intended application and use environment. Certain features of the illustrated embodiments may have been enlarged or distorted relative to others to facilitate visualization and provide a clear understanding.

### DETAILED DESCRIPTION

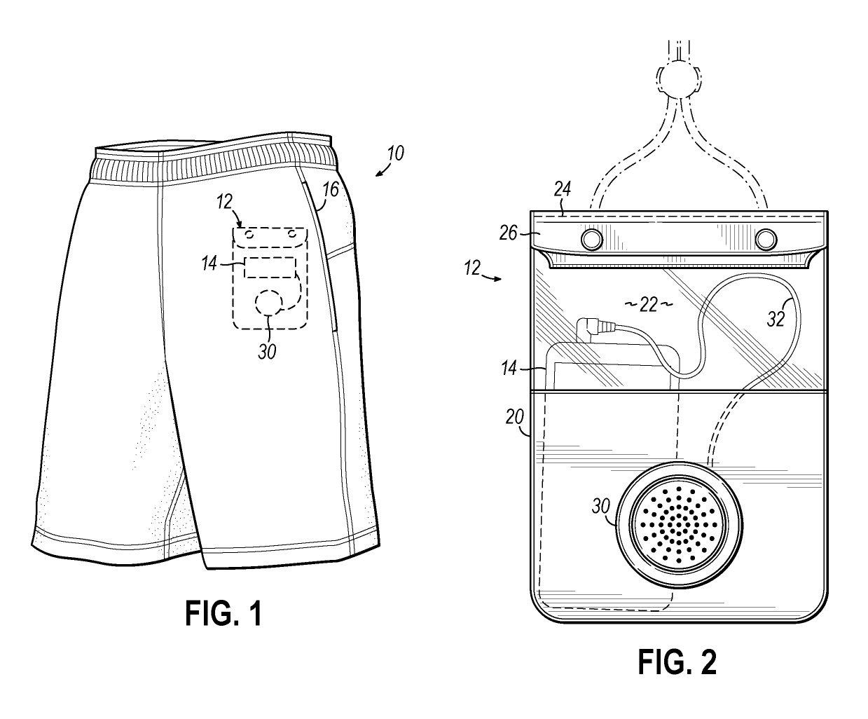

FIG. 1 depicts an exemplary garment 10, in the form of swim trunks, which may be worn by a user during the enjoyment or performance of sport or leisure activities where the user and garment 10 may be exposed to water. A waterproof electronic device receptacle 12 is coupled with the garment 10 for receiving and containing a personal electronic device 14 such as a cellular telephone, a digital audio player, or any other electronic device. The receptacle 12 may be provided in a pocket 16 of the garment 10, or may be attached to an inner surface or an outer surface of the garment 10, or at any other suitable location on the garment 10. The receptacle 12 may be selectively removably coupled to the garment 10, such as by buttons, zippers, snaps, hook-and-loop type fasteners (such as Velcro®), or by any other suitable method. Alternatively, the receptacle 12 may be permanently coupled with the garment 10, such as by stitching, riveting, or other suitable methods. The receptacle 12 may also be attached to the garment 10 by a flexible tether to facilitate limited movement of the receptacle 12 relative to the garment 10, while still securing the receptacle 12 to the garment 10.

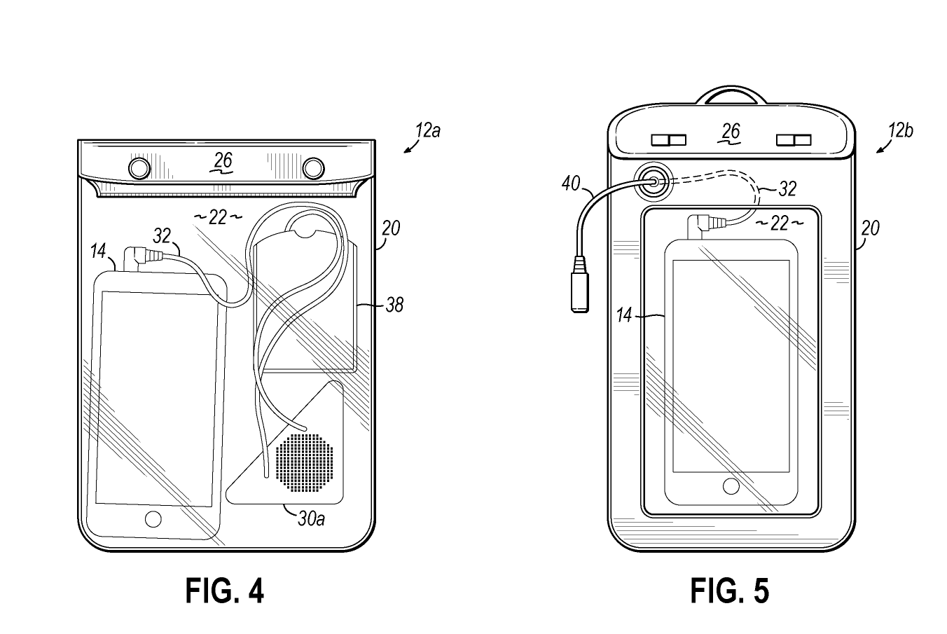

FIGS. 2-4 depict different embodiments of waterproof electronic device receptacles 12, 12a in accordance with the principles of the present invention. With continued reference to FIG. 1, and referring further to FIGS. 2, 3A, 3B, and 4, the waterproof electronic device receptacle 12, 12a comprises a flexible enclosure 20 having an interior reservoir 22 sized to receive the personal electronic device 14. In the embodiment shown, the receptacle 12, 12a has a generally rectangular shape. However, it will be appreciated that the receptacle 12, 12a may have various other shapes suitable for receiving a personal electronic device 14 and for being coupled with a garment 10. At least one end of the receptacle 12, 12a includes an opening 24 that provides access to the interior reservoir 22 for receiving and removing the personal electronic device 14. A selectively sealable closure 26 is provided adjacent the opening 24 to thereby seal the interior reservoir 22 against the intrusion of water, so that a personal electronic device 14 disposed therein is protected from exposure to water or other liquids. The sealable closure 26 may comprise a zipper-type seal, or various other structures suitable to facilitate sealing the enclosure 20 against intrusion of water or other liquids.

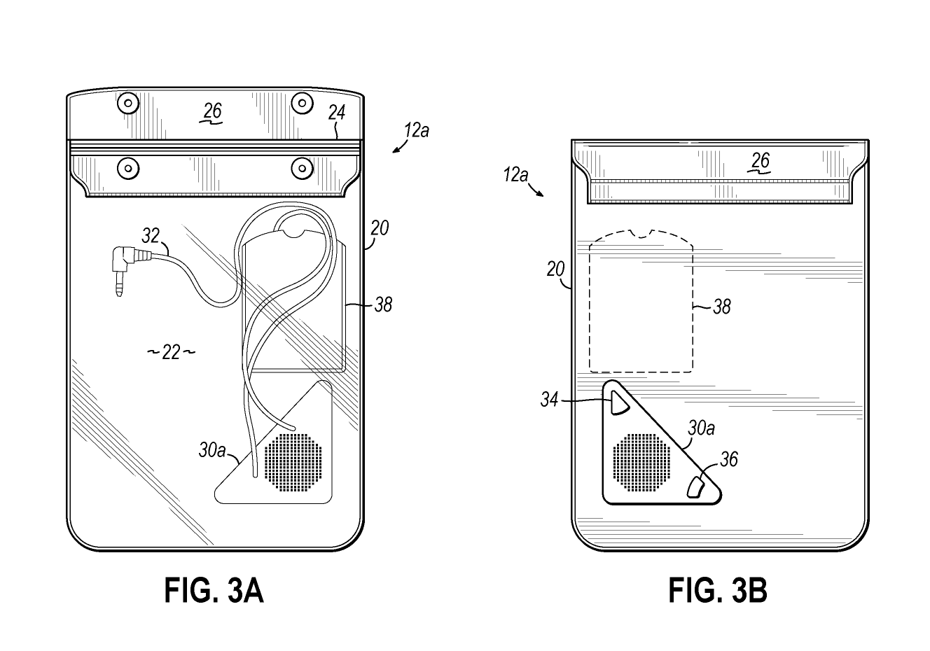

The waterproof electronic device receptacle 12, 12a may further include a waterproof speaker 30, 30a coupled with the flexible enclosure 20. In the embodiments shown, the speaker 30, 30a is depicted on a side panel of the enclosure 20. However, it will be appreciated that the speaker 30, 30a may be located on various other portions of the enclosure 20, as may be desired. The receptacle 12, 12a further includes a speaker input connection 32 coupled with the speaker 30 and configured to be connected with an electronic device 14 disposed within the reservoir 22. When the electronic device 14 is disposed in the reservoir 22 and sealed with the closure 26, a user may operate the electronic device 14 whereby the speaker 30, 30a transmits audio signals from the electronic device 14 such that the audio signals can be heard by the user during enjoyment of leisure or sports activities in and around water. Controls may be provided on the speaker 30, or other suitable structure, for adjusting the volume of sound transmitted by speaker 30 or for performing various other functions. In the embodiment shown in FIG. 3B, the speaker 30a includes controls in the form of a button 34 for controlling the volume of sound, and a button 36 for controlling power to the speaker 30a. The waterproof electronic device receptacle 12, 12a may further include a pocket 38 or other structure (best seen in FIGS. 3A and 3B) for receiving one or more batteries (not shown) within the interior reservoir 22 to provide power to speaker 30.

In another embodiment, the waterproof electronic device receptacle 12b may further include a waterproof output connection, or jack, communicating with the exterior of the reservoir 22 and configured to receive a corresponding connection to waterproof headphones, ear buds, or other suitable components that can play audio signals from the electronic device 14 disposed within the interior reservoir 22. FIG. 5 depicts an exemplary embodiment of a waterproof electronic device receptacle 12b having a waterproof output connection 40 that can be coupled with an electronic device 14 disposed in the reservoir 22, and also with headphones, ear buds, or other suitable components (not shown) outside the receptacle 12b. In this embodiment, the waterproof electronic device receptacle 12b does not include a speaker as described above. However, it will be appreciated that other embodiments of a waterproof electronic device receptacle 12b having an output connection 40 may also include a waterproof speaker as described above.

In some embodiments, the waterproof electronic device receptacle 12, 12a, 12b may be constructed of materials that facilitate manipulation and operation of the electronic device 14 disposed in the interior reservoir 22, such as, but not limited to, thermoplastic urethane (TPU), polyvinyl chloride (PVC), or other suitable materials. For example, at least a portion of the flexible enclosure 20 may comprise a material that facilitates actuation and operation of an electronic device 14 having touch screen functionality while the device 14 is disposed within the interior reservoir 22 of the receptacle 12, 12a, 12b. In another embodiment, at least a portion of the flexible enclosure 20 may comprise a material that is transparent, or at least translucent, so that the electronic device 14 may be operated to take photographs while disposed within the interior reservoir 22 and while the waterproof electronic device receptacle 12, 12a, 12b is underwater. Advantageously, the waterproof electronic device receptacle 12, 12a, 12b enables users to operate the electronic device 14 without having to access the device 14 through the opening 24.

In another embodiment, the speaker 30, 30a may be adapted to receive audible commands from a user and transmit corresponding signals to the electronic device 14 disposed within the interior reservoir 22, such as by speaker input connection 32 or other suitable connections with the electronic device 14. Alternatively, the receptacle 12, 12a, 12b may further include a separate microphone (not shown) adapted to receive audible commands from a user and transmit corresponding signals to an electronic device 14 disposed within the interior reservoir 22.

While the garment 10 has been shown and described herein as comprising swim trunks, it will be appreciated that the garment 10 may alternatively be styled in the form of a bikini, a tank top, or various other garments intended for use in and around a wet environment. In another embodiment, the garment 10 may further include a waterproof lining coupled with the garment 10 and sized to receive the waterproof electronic device receptacle 12, 12a, 12b therein.

While the present invention has been illustrated by a description of one or more embodiments thereof, and while these embodiments have been described in considerable detail, they are not intended to restrict or in any way limit the scope of the appended claims to such detail. Additional advantages and modifications will readily appear to those skilled in the art. Moreover, it should be appreciated that the various features, applications, and devices disclosed herein may also be used alone or in any combination. The invention in its broader aspects is therefore not limited to the specific details, representative apparatus and method, and illustrative examples shown and described. Accordingly, departures may be made from such details without departing from the scope of the general inventive concept.

What is claimed is:

1. An article of swimming apparel, comprising:
a swimsuit adapted for wear by a user in a wet environment; and
a waterproof electronic device receptacle operatively coupled with the swimsuit, the receptacle comprising:
a flexible enclosure having an interior reservoir sized to receive a personal electronic device,
a selectively sealable opening providing access to the interior reservoir,
a waterproof speaker coupled with the flexible enclosure, and
a speaker input connection coupled with the speaker and configured for connection to the electronic device when the electronic device is received in the reservoir,
whereby the speaker transmits audio signals from the electronics device such that the audio signals can be heard by the user when the electronic device is sealingly enclosed within the receptacle.

2. The article of claim 1, wherein the waterproof electronic device receptacle is selectively removably coupled with the swimsuit.

3. The article of claim 1, wherein at least a portion of the receptacle comprises a material that facilitates touch screen functionality of an electronic device received in the reservoir.

4. The article of claim 1, wherein the speaker is further adapted to receive audible commands from the user and transmit corresponding signals to the electronics device via the speaker input connection.

5. The article of claim 1, further comprising:
a microphone associated with the receptacle and adapted to receive audible commands from the user and transmit corresponding signals to the electronics device via the speaker input connection.

6. The article of claim 1, further comprising:
a waterproof lining coupled with the swimsuit;
the waterproof electronic device receptacle disposed within the waterproof lining when the waterproof electronic device receptacle is coupled with the swimsuit.

7. The article of claim 1, wherein at least a portion of the receptacle comprises a transparent or translucent material that facilitates taking pictures with an electronic device disposed in the reservoir.

8. An article of swimming apparel, comprising:
a swimsuit adapted for wear by a user in a wet environment; and
a waterproof electronic device receptacle operatively coupled with the swimsuit, the receptacle comprising:
a flexible enclosure having an interior reservoir sized to receive a personal electronic device,
a selectively sealable opening providing access to the interior reservoir,
a waterproof speaker coupled with the flexible enclosure,
an input connection configured for connection to the electronic device when the electronic device is received in the reservoir, and
a waterproof output connection communicating with the input connection and extending outside the flexible enclosure for coupling to components disposed outside of the waterproof electronic device receptacle.
